(19) United States
(12) Patent Application Publication
(10) Pub. No.: US 2026/0044164 A1
(43) Pub. Date: Feb. 12, 2026

(54) COOKTOP ISOLATION RINGS

(71) Applicant: Henry FRANKOWSKI, West Stockbridge, MA (US)

(72) Inventor: Henry FRANKOWSKI, West Stockbridge, MA (US)

(21) Appl. No.: 19/295,336

(22) Filed: Aug. 8, 2025

Related U.S. Application Data
(60) Provisional application No. 63/681,108, filed on Aug. 8, 2024.

(51) Int. Cl. G05D 23/27; F24C 3/12; F24C 7/08; F24C 15/10; F24C 15/34; G01J 5/10; G01J 5/52; G01J 5/80

(52) U.S. Cl. CPC G05D 23/27; F24C 3/122; F24C 7/088; F24C 15/101; F24C 15/34; G01J 5/10; G01J 5/52; G01J 5/80

(57) ABSTRACT

A system comprises at least two insulating rings and a heating ring forming a perimeter around an outer of the at least two insulating rings. The system also includes a cooking vessel positioned on the flat top surface of the at least two insulating rings, wherein a portion of the cooking vessel and the innermost ring of the rings form a circular chamber and a sensor comprising an infrared pyrometer and a laser pointer which detects a temperature of a target surface of the cooking vessel. The system includes a control system communicatively coupled to the sensor and to at least one control device and a control device, where the control device controls power output to the heating ring and the control device is communicatively coupled to the control system.

### CROSS REFERENCE TO RELATED APPLICATION

The present invention claims priority from U.S. provisional patent application No. 63/681,108, filed Aug. 8, 2024, which is hereby incorporated herein by reference in their entirety.

### BACKGROUND OF INVENTION

Traditional cooktops, especially those powered by gas, can pose several health and safety risks to individuals using them to cook in addition to individuals within the vicinity of these systems. One major concern is indoor air pollution; gas stoves release nitrogen dioxide (NO₂), carbon monoxide (CO), and other pollutants, which can exacerbate respiratory conditions like asthma and increase the risk of long-term health problems. These emissions often occur even when the stove is off due to small gas leaks. There is also a significant fire and burn risk from open flames, hot surfaces, and flammable materials nearby. If a burner is accidentally left on, either with or without a pot on top, it can lead to fires, overheating, or dangerous gas buildup. This risk is especially high in homes with children, elderly residents, or individuals with memory impairments. Additionally, electric coil stoves, while not emitting gases, retain heat for long periods and can be visually misleading when hot, increasing the risk of burns or fire if objects are placed on them too soon.

Thus, while traditional cooktops are common, their use carries significant safety risks, including pollution, fire, burns, and human error due to manual controls, that cannot always be mitigated, even with proper ventilation, attentiveness, and/or by switching to newer technologies like induction cooktops with automatic shutoff features. But many existing automatic shutoff features have limitations. For example, timers used to shut off cooktops are not always context aware. Utilizing a timer merely to turn off a cooktop after a preset duration, may or may not prevent forgotten burners from overheating, and this timer does not distinguish between active cooking and actual neglect. This can result in unintended interruptions while cooking slow-simmering dishes or meals that require extended heat. Additionally, existing approaches do not include effective sensor integrations. One approach includes aftermarket shutoff devices, but this approach does not include a means of detecting the presence of a pot, temperature changes, or motion in the kitchen. Without these data, a cooktop system cannot adapt to real-time activity, reducing its effectiveness and convenience. Additionally, existing systems do not include facilities to detect dangerous conditions, including but not limited to gas leaks, smoke, or flammable objects on or near the stove. As such, these existing systems fail to prevent fires caused by grease, dish towels, or paper products catching flame, and will also fail to detect a burner left on with no flame due to a gas outage or wind extinguishing the flame. Another issue is that enhancements, which could include automatic features, are not compatible with older stoves and retrofitting these stoves can be complex, expensive, or not feasible without replacing the appliance. Additionally, some existing solutions include overrides to disable safety settings (e.g., manual overrides or bypasses), which can be easily activated intentionally or accidentally, which defeats the purpose of the safety mechanism. Finally, present cooktops which prioritize safety do not always take into account the quality of the food prepared, nor the preservation of resources utilized in the cooking process. Many safety mechanisms are not linked to food quality or resource conservation.

### SUMMARY OF INVENTION

Shortcomings of the prior art are overcome, and additional advantages are provided through the provision of a system for controlling cooking temperature in a cooking vessel. The system includes, for instance: at least two insulating rings, each ring with a flat top surface and a flat bottom surface, positioned concentrically to each other with a first distance separating each insulating ring of the at least two insulating rings from a next insulating ring of the at least two insulating rings, wherein the flat bottom surface of each ring is positioned on a top surface of a range such that an upper surface of the range is in physical contact with at least a portion of the flat bottom surface of each ring, and wherein a first ring is an innermost ring and a second ring is an outmost ring; a heating ring comprising a bottom surface, wherein the heating ring is positioned on the top surface of the range and around a perimeter of the outermost ring of the at least two insulating rings, wherein a second distance separates the heating ring from the outermost ring; a cooking vessel positioned on the flat top surface of the at least two insulating rings, wherein a portion of the cooking vessel and the innermost ring form a circular chamber; a sensor comprising an infrared pyrometer and a laser pointer, wherein the infrared pyrometer detects a temperature of a target surface of the cooking vessel, wherein the target surface is a location on a bottom surface of the cooking vessel accessible to the infrared pyrometer based on utilizing a laser pointer to emit a laser perpendicular to the upper surface of the range through the circular chamber to guide the infrared pyrometer; a control system communicatively coupled to the sensor and to at least one control device; and a control device, wherein the control device controls power output to the heating ring and the control device is communicatively coupled to the control system.

Shortcomings of the prior art are overcome, and additional advantages are provided through the provision of a system for controlling cooking temperature in a cooking vessel. The system includes, for instance: an insulating element, wherein the insulating comprises a flat top surface and a flat bottom surface, wherein the flat bottom surface is positioned on a top surface of a range such that an upper surface of the range is in physical contact with at least a portion of the flat bottom surface; a heating ring comprising a bottom surface, wherein the heating ring is positioned on the top surface of the range forming a perimeter around the insulating element; a cooking vessel positioned on the flat top surface of the insulating element; a sensor comprising an infrared pyrometer and a laser pointer, wherein the infrared pyrometer detects a temperature of a target surface of the cooking vessel, wherein the target surface is a central location on a bottom surface of the cooking vessel; a control system communicatively coupled to the sensor and to at least one control device; and a control device, wherein the control device controls power output to the heating ring and the control device is communicatively coupled to the control system.

Shortcomings of the prior art are overcome, and additional advantages are provided through the provision of a system for controlling cooking temperature in a cooking vessel. The system includes, for instance: an insulating element comprising a spiral shape, wherein the spiral shape has a flat top surface and a flat bottom surface, wherein the flat bottom surface is positioned on a top surface of a range such that an upper surface of the range is in physical contact with at least a portion of the flat bottom surface; a heating ring comprising a bottom surface, wherein the heating ring is positioned on the top surface of the range forming a perimeter around the insulating element; a cooking vessel positioned on the flat top surface of the insulating element; a sensor comprising an infrared pyrometer and a laser pointer, wherein the infrared pyrometer detects a temperature of a target surface of the cooking vessel, wherein the target surface is a central location on a bottom surface of the cooking vessel; a control system communicatively coupled to the sensor and to at least one control device; and a control device, wherein the control device controls power output to the heating ring and the control device is communicatively coupled to the control system.

Methods and systems relating to one or more aspects are also described and claimed herein. Further, services relating to one or more aspects are also described and may be claimed herein. Additional features are realized through the techniques described herein. Other embodiments and aspects are described in detail herein and are considered a part of the claimed aspects.

It should be appreciated that all combinations of the foregoing aspects and additional concepts discussed in greater detail below (provided such concepts are not mutually inconsistent) are contemplated as being part of the inventive subject matter and to achieve the advantages disclosed herein.

### BRIEF DESCRIPTION OF DRAWINGS

One or more aspects of the present invention are particularly pointed out and distinctly claimed as examples in the claims at the conclusion of the specification. The foregoing and objects, features, and advantages of one or more aspects of the invention are apparent from the following detailed description taken in conjunction with the accompanying drawings.

FIG. 1 is an illustration of various aspects of the systems described herein.

FIG. 2 is an illustration of various aspects of the systems described herein.

FIG. 3 is a workflow that illustrates various aspects of some embodiments of the present invention.

FIG. 4 is a workflow that illustrates various aspects of some embodiments of the present invention.

FIG. 5 illustrates a block diagram of a resource in a computer system, which is part of the technical architecture of certain embodiments of the technique.

FIG. 6 illustrates a computer program product which includes one or more non-transitory computer readable storage media to store computer readable program code means or logic thereon to provide and facilitate one or more aspects of the technique.

### DETAILED DESCRIPTION OF THE INVENTION

Disclosed herein are one or more systems, one or more methods of use, and one or more methods of manufacturing, where the aforementioned system is part of a stovetop cooking system which enhances safety, efficient resource utilization, and food quality, for users. To that end, certain of the examples herein include a closed-loop control system for a cooktop which can regulate the cooking temperature of a cooking vessel (e.g., pot, pan, etc.) in use on a burner of the cooktop. A closed-loop system can be contrasted with an open loop system where refers to a type of stove or cooktop system where there is no feedback mechanism to automatically monitor and adjust the heat or shut off the system. These open loop systems rely entirely on manual control by the user, which can introduce safety and efficiency risks (and also compromise the quality of the food prepared). Open loop heating (for cooking) can lead to dangerous incendiary temperatures, a risk which is eliminated by the use of the examples herein.

Closed-loop heating in the context of cooking on a cooktop refers to a system that continuously monitors and adjusts heat output to maintain a consistent and precise cooking temperature. The closed-loop systems described herein include at least one sensor which can obtain feedback for use by a control system to regulate, among other things, the power sent to the heating element. In the examples herein, temperature sensors (e.g., thermocouple and/or infrared sensors) are advantageously placed to continuously monitor cooking temperature. In the examples, herein, a sensor can provide feedback to a control element, such as a microcontroller or microprocessor which, for example, can compare the measured temperature (from the sensor) with a target (set) and/or threshold temperature and make adjustments to the power supply to the heating element(s) of the stovetop based on this comparison. Thus, based on receiving these data, the program code executing on the microcontroller can both determine whether to adjust the temperature and can implement this adjustment (including providing the adjustment to elements of a control system communicatively coupled to the microcontroller, which implements the commands). For example, if the program code executing on the microcontroller determines that actual temperature differs from a target temperature, the program code can automatically increase or decrease the heat output to correct it (or provide a command to a control element to implement this change). In the context of the examples herein, program code can refer to both software and/or hardware. In some examples herein, the monitoring and adjustment of the temperature can be continuous to maintain stable and even heating.

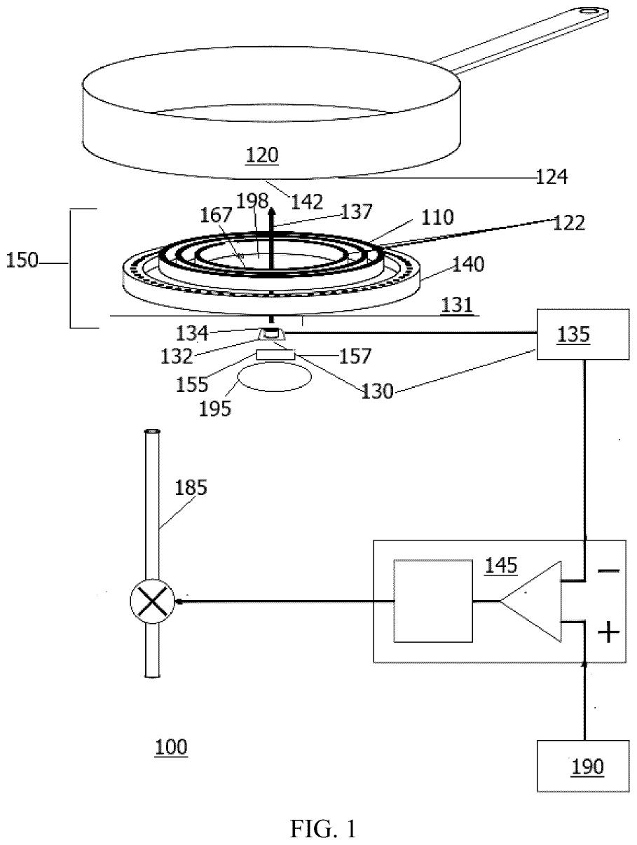

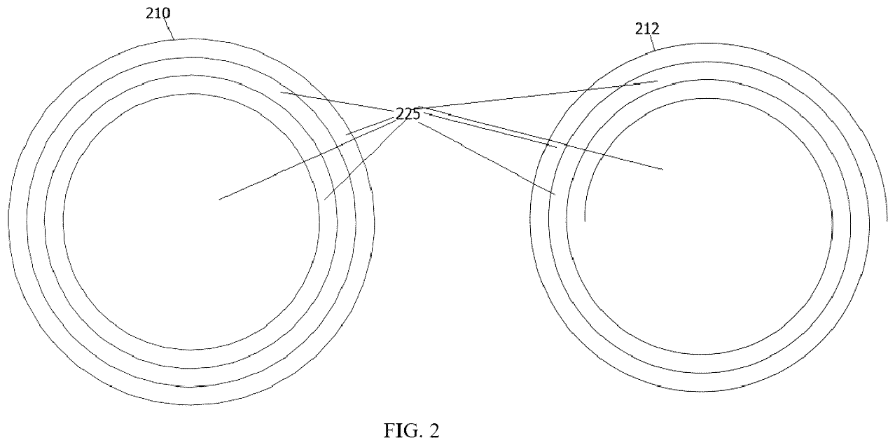

FIG. 1 illustrates aspects of a closed loop cooking system 100 which includes aspects described herein. The system 100 includes a cooktop 131 (e.g., range) with at least one burner assembly 150. The burner assembly 150 includes: 1) isolation and support elements; and 2) at least one heating element. The term burner assembly 150 is used broadly to represent the element of the cooktop that both holds and heats a cooking vessel, although different elements in the assembly can handle each of these elements, exclusively, depending on the configuration of the example implemented. The cooking vessel 120 in this example has a non-reflective bottom. In examples where different elements of the burner assembly 150 accomplish these tasks separately, as will be discussed below, the heating element does not support the cooking vessel, and the support element does not heat the cooking vessel 120. The support element are concentric rings 110 or a spiral (both pictured in FIG. 2) while the heating element 140 is an outer ring. As will be discussed in greater detail herein, to utilize the system to cook (safely) and to take advantage of the automated closed loop controls, the system includes a heating element 140, to heat a cooking vessel 120, to enable cooking, but to monitor the temperature of the cooking, the system 100 includes a sensing element 130 which includes an element to obtain the temperature of a cooking vessel 120 on the cooktop and an element to receive the temperature and provide it to a control system. The integrity of the temperature measurements obtained by the sensing element 130 are maintained based on the inclusion of the aforementioned concentric rings 110 (or spiral), which not only support the cooking vessel 120, but also prevent temperature interference with the sensing element 130 such that the temperature measured by the sensing element 130 is accurate. Because the concentric rings 110 ensure accurate measurements, the automated functionality based on the measurements is similarly useful. Based in measurements received from the sensing element 130, a control system (e.g., program code executing on a microprocessor) 145 can automatically vary power output of the heating element 140. To adjust the power output, the program code of the control system 145 can control various devices 185 in the system 100 responsible for providing power to the heating element 140, including a gas valve. If the system is an electric appliance, the various devices 185 controlled by the control system 145 can include, but are not limited to, electronic switching devices such as a MOSFET, IGBT, SCR or TRIAC, which can control the amount of electrical power delivered to the heating element 140. As discussed here, the system 100 can also include an air pump or fan blower 195 to optimize the performance by generating a small positive pressure in the central area of the burner assembly 150, to push heat outward. A user can monitor the functionality of the system 100 via a user interface 190, which is communicatively coupled to the control system 145.

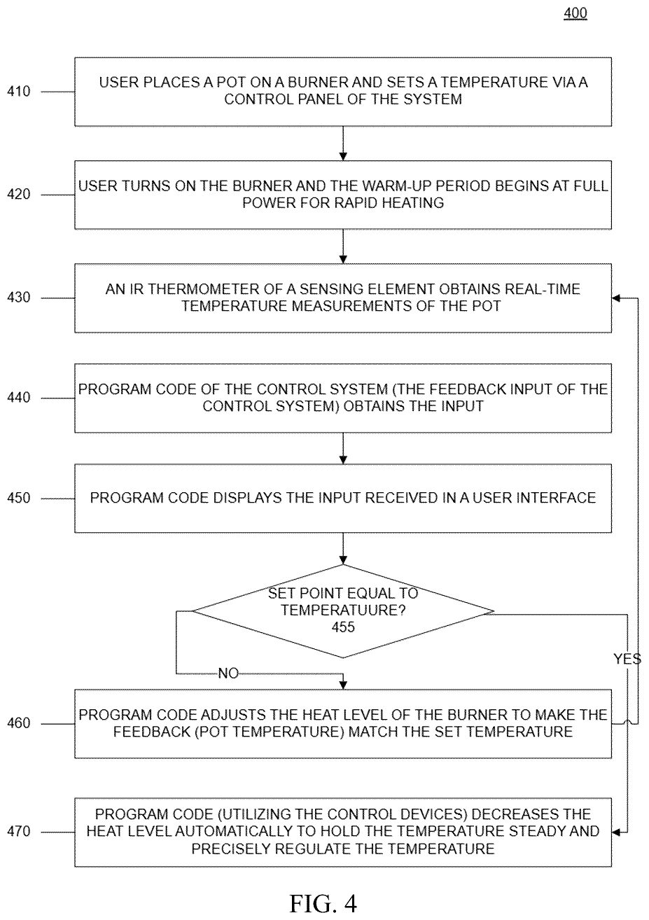

The examples herein provide various benefits over conventional cooktops. The automated temperature (and cooking) controls could arguably eradicate cooking-related fires in the home, and the resulting structure fires that kill or injure thousands of people each year, render housing uninhabitable and displace families. The reduction in fires will create a reduction in emergency calls, and the related resources expended by municipal fire services. The exact and controlled cook times and temperatures enabled by the examples herein result in a highly efficient and arguably greener design which conserves energy. Energy is conserved through the process described in FIG. 4, unattended warm-up time due to full-power warm-up periods, followed by automatic rollback (heat reduction). In electrical stoves, temperature overshoots can also be mitigated if not eliminated entirely. The system can also be programmed to conform to any safety regulations, for example, relating to power and gas usage.

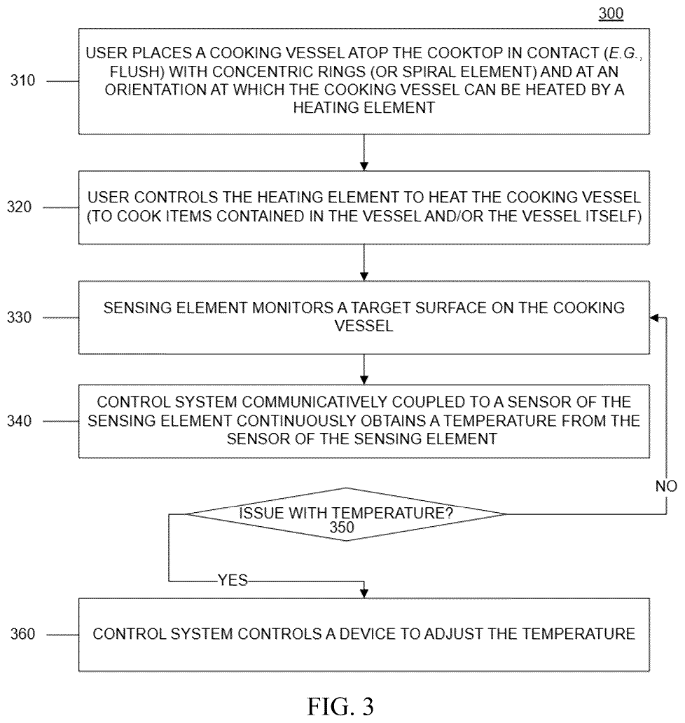

As an overview before parsing the particulars of FIG. 1-2, which illustrate various aspects of the system 100, and FIGS. 3-4, which are workflows 300 400 describing the system 100 uses, various overall elements are noted. For example, the cooking plane for this system 100 is a horizontal plane where the top surface of the thermal isolation rings (concentric rings 110) meets the base of the cooking vessel 120. In the case of an electric stove, the cooking plane may include the heating element(s), whereas a gas burner must reside below the cooking plane to allow flames to rise. Each burner assembly 150 has an opening 167 at the center of its concentricity and at the cooking plane, to allow the sensing element 130, which includes an infrared pyrometer laser to be directed through it, at the bottom center of the cooking vessel. This opening 167 can also be understood as a central chamber 198.

Returning to FIG. 1, the isolation and support element of the burner assembly 150 comprises concentric rings 110 (or a spiral). In this example, there are two concentric rings 110, however, this number of rings is provided as an example and not to introduce any limitations. When the system 100 is utilized as a cooktop, these concentric rings 110 form thermal (isolation) barriers in addition to being a (support) surface upon which a cooking vessel 120 can be placed so that the contents of the cooking vessel 120 can be cooked using the system 100. The concentric rings 110 comprise an upper surface 122 upon which the cooking vessel 120 is positioned (preferably flush). The concentric rings 110 themselves are positioned atop a range upper surface 119. When the system 100 is utilized for cooking, the cooking vessel 120 is positioned atop the concentric rings 110 such that the isolation rings are in contact with cooking vessel 120 (and support the cooking vessel 120). The performance of the system 100 can be improved based on the quality of the contact maintained between the cooking vessel 120 and the upper surface 122 of the concentric rings 110. The concentric rings 110 facilitate accurate pyrometry readings, as they are designed to block the inward flow of flames and superheated gases, which would otherwise travel to the center of the burner assembly. Although FIG. 1 depicts this element as rings, the thermal isolation (and support) element can consist of a series of concentric rings or may embody the configuration of a single, continuous spiral. The concentric rings 110 create one or more concentric circular chambers to trap or block air.

The cooking vessel 120 illustrated in FIG. 1 is an example of a cooking vessel 120 as various vessels can be heated (for cooking items inside) with the system 100 of FIG. 1. A circular cooking vessel 120 was selected for illustrative purposes only. Both insulation and support elements, the concentric rings 110 and the spiral configuration are a safety measure and enable the efficacy for automatic temperature control because they prevent potentially dangerous biproducts of cooking with this system 100, e.g., hot ionized gas, flame and/or superheated air from entering (e.g., leaking into) the central chamber 198, where the sensing element 130 utilized in the system 100. For case of understanding, FIG. 1 illustrates the concentric rings 110 insulation and support configuration, but both the concentric rings 210 and the spiral 212 examples are illustrated in FIG. 2, from a top view perspective. Unless stated otherwise, throughout the description provided of FIG. 1, the spiral 212 can be substituted for the concentric rings 210 (FIG. 1, 110).

Returning to FIG. 1, the concentric rings 110 (and hence, the spiral 212) are a support mechanism for a cooking vessel 120 as the cooking vessel 120 rests squarely (e.g., flat) on an upper horizontal surface of the concentric rings 110. At this orientation, as illustrated in FIG. 2, two or more concentric, circular chambers 225 (FIG. 2) are formed between the base of cooking vessel 120 and the spaces between each of the concentric rings 110. As aforementioned, the number of concentric rings 110 can vary, but as the rings create these isolation chambers, for example, three rings would create two enclosed chambers in addition to a central chamber, where a sensing element 130 of the system 100 senses a temperature of the cooking vessel 120. It is these isolation chambers (defined by the space between the rings and the bottom surface 124 of the cooking vessel 120 flush to the upper surface 122 of the concentric rings 110, which define the isolation chambers.

To maintain an optimal fit between the concentric rings 110 and the cooking vessel 120 (as the cooking vessel 120 is positioned atop the concentric rings 110), the concentric rings 110, in some examples, can be spring loaded or otherwise integrated with flexible elements such that they can move up and down slightly to achieve and maintain contact with the cooking vessel 120 as the cooking vessel 120 could be jostled while in use. Adding elements to the concentric rings 110, such as these springs, enables them to conform to a cooking vessel 120 to maintain contact enables the system 100 to accommodate cooking vessels 120 of varying and sometimes odd shapes (e.g., non-symmetrical). For example, a spring loaded isolation rings can conform to a pot bottom that is warped or slightly curved, whereas to maintain contact during cooking with a cooking vessel 120 which is a highly curved pot, such as a wok, the concentric rings 110 can be supplemented with a structure to maintain the connection between the concentric rings 110 and the cooking vessel 120 during cooking. As the fit between the concentric rings 110 and the cooking vessel 120 can impact the temperature determination, in some examples, to better accommodate small cooking vessels, a stove design may have a smaller, burner with, e.g., two rings rather than three. The concentric rings 110 (or spiral) can be mounted on the same surface as the burner portion of the burner assembly. Although there are relative heights depicted in FIG. 1, the height of the rings can vary depending on the specific design, including whether the heating is gas, electric, induction, or other, and/or the relative vertical positions of each component. Additionally, the spacing between the rings can vary and can be made smaller to accommodate a small diameter burner.

The concentric rings 110 guard the integrity of the temperature measurements by the sensing element from items including the heating element of the burner assembly 150. As illustrated in FIG. 1, the heating element is a circular heating element 140. This circular heating element 140 is positioned outside of and surrounding the concentric rings 110, located at the outermost concentricity and comprising a largest diameter of the circular elements of the burner assembly 150 (e.g., a larger diameter than the concentric rings 110). The heating element 140 can be a gas burner, circular heating element, and/or an induction heater. The type of heating used in the system 100 can dictate the configuration of the heating element 140 relative to the cooking vessel 120. The heating element 140 can be an induction heater, which uses electromagnetic induction to heat electrically conductive materials, typically metals, without direct contact or open flame. In this configuration, proximate location, as opposed to direct contact, between the heating element 140 and the cooking vessel 120, can be used. In examples of the system 100 that utilize induction heating, the cooking vessel 120 is essentially the heating element, as opposed to the cooktop surface. Hence, the cooking vessel 120 can be comprised of magnetic elements, including but not limited to, cast iron, stainless steel with magnetic base, etc. However, in examples of the system which utilize electric or gas heating for the heating element 140, a rack (not pictured) can be added to bridge heat from the heating element 140 with the cooking vessel 120, while also providing additional support to the cooking vessel 120. For example, if the system 100 utilizes gas fuel, the closed loop cooking system 100 can include a traditional steel or cast-iron top rack (e.g., grate). The rack used on gas stovetops not only provides air space above the burner for flames to rise but can also provide a wider and more stable cooking surface to prevent larger pots from tipping. In this configuration, the rack, in addition to the concentric rings 110 makes direct contact with the cooking vessel 120 to enable cooking. In examples where the system 100 comprises an electric cooktop, the heating element 140 can make contact with the cooking vessel 120, in addition to the concentric rings 110 (e.g., the heat isolation element) making contact. In certain of these examples, a rack can be added to the (electric) cooktop to enable the heating element 140 to maintain this contact. To enable the concentric rings 110 (isolation element) to maintain contact with the cooking vessel 120 while enabling the heating element 140 to heat the cooking vessel 120, in some examples, the aforementioned top rack and concentric rings 110 could be fabricated from one integral piece or could rest on a common reference surface. This reference structure (not pictured in FIG. 1), could include a bottom pan (not pictured in FIG. 1) either as support surface or as an integral piece to maintain the contact described herein to the cooking vessel 120.

When the heating element 140 of the burner assembly 150 (the burner assembly 150 refers generally to the two concentric rings 110 and the circular heating element 140), is utilized to heat or cook the contents of a cooking vessel 120, a sensing element 130 comprising IR pyrometer 132 and/or a laser emitting diode (LED) 134, which can be understood as a laser pointer which guides an infrared pyrometer on a path 137 to obtain a temperature from IR emissions from the cooking vessel 120. A sensor 135 obtains the reading of the IR emissions and converts it to a temperature value. Thus, the sensor 135 (via the infrared pyrometer with the assistance of a laser pointer for guidance) monitors a bottom surface 160 of the cooking vessel 120. The LED 134 (providing the laser pointing guide) can be positioned in the center of the burner assembly 150 (e.g., a gas burner or heating element) such that it emits a laser upwards from a horizontal surface of the system (upon which the concentric rings 110 and the circular heating element 140 can be situated, for example, these portions of the sensing element can be situated on the cooktop 131 or range) toward the base 180 of the cooking vessel 120. The location of the IR emissions from the cooking vessel 120 obtained by the IR pyrometer 132 are indicated by the laser from the LED 134. Hence, the geometrical center of the circular arrangement of system components is the location 142 that the pyrometer uses for sensing the temperature of the cooking vessel 120 based on sensing emissions from this location on the cooking vessel 120.

The sensor 135 in the sensing element 140 continuously reads the temperature data obtained by the IR pyrometer 132 guided by a path 137 from a laser or LED 134 (e.g., a laser pointer guides the IR pyrometer). Because heat naturally rises due to natural convection, the sensing element 130 of the system 100 can accurately (indirectly) measure a cooking temperature based on sensing (e.g., measuring) a location at a center of a base of the cooking vessel 120. This measurement is indirect because it is the IR which monitors the temperature. The cooking vessel 120 in this example is depicted as circular, as are the burner assembly 150 elements, but the shapes of the various elements can vary provided that a central location on the cooking vessel 120 is monitored by the sensing element 130 of the system 100.

As discussed herein, the sensing element 130 can include an infrared pyrometer. The sensing element 130 can detect infrared radiation emitted by the target surface and converts it into a temperature reading. The infrared pyrometer can comprise a laser pointer, which guides to aim the pyrometer precisely. All objects (e.g., the cooking vessel 120) emit infrared radiation based on their temperature. The pyrometer (as part of the sensing element 130) detects this IR radiation. The pyrometer calculates the surface temperature (at the target surface) based on the intensity and wavelength of the radiation. The pyrometer can provide the calculated temperature to the control system 145.

The sensing element 130 can include printed circuit board with infrared pyrometer components. This printed board can be mounted vertically and axially aligned with a concentric center of the system to utilize the cooling effect of the upward moving airstream inside the baffle or tube. The printed circuit board can also be mounted horizontally or in any other orientation if the airflow is directed accordingly, and as long as IR pyrometer 132 (which measures IR emissions from the cooking vessel 120, as guided by a path 137 from a laser or LED 134) can be positioned in a manner where the laser can be aimed directly at the bottom center of the cooking vessel 120, indicating that the IR pyrometer 132 has a clear path 137 to measure the IR emissions from the cooking vessel 120. The LED laser pointer and the IR detector (e.g., the IR pyrometer 132) are part of the printed circuit board (PCB). When the range or stovetop is first constructed, the orientation of the laser pointer, and thus the infrared detector, can be aimed or set to the center of concentricity, so that this adjustment is only made this one time.

The sensing element 130 can also include an air channel 155 in the configuration, which preserves the functionality of the PCB under the hot conditions in the system 100. In some examples, the air channel 155 is created by a round or rectangular tube, or a series of baffles or plates to simulate a tube or channel. In some examples, the air channel 155 is fabricated from a steel tube or two or more pieces of sheet steel. The length of the air channel 155 can vary but the air channel 155 directs the flow of cool air past the printed circuit board, and into the central chamber 198. In some examples, the printed circuit board (infrared pyrometry assembly and/or components) of the sensing element 130 is located inside of the air channel 155. The pyrometer assembly can be positioned at (or near to) the bottom opening of this air channel 155 where air is being forced in. FIG. 1 depicts a vertical air channel 155 (perpendicular to the cook surface) but this air channel 155 can also be horizontal with an elbow (e.g., a 45-degree baffle or deflector) below the center of concentricity, to redirect horizontally moving air upward, and into the vertical direction (perpendicular to the cook surface). The air channel 155 can comprise relief holes 157. When the isolation and support element is concentric rings 110, air can be blocked rather than allowed to move past the concentric rings 110. Thus, in some examples, air channel 155 can have one or more small openings, slots or relief holes 157 at its upper end, to allow air to escape the channel. These relief holes 157 enable air movement and mitigate the system 100 elements forcing air upward into a blocked (e.g., with the cooking vessel 120) channel. To maintain higher pressure with use of a fan or pump 195 in examples with concentric rings 110, relief holes 157 can be omitted, however these relief holes can be included when the isolation and support element is a spiral 212.

The concentric rings 110 in the system 100, which can be understood as isolation elements, create a separation or thermal barrier between heating element 140 of the burner assembly 150, and a target surface (e.g., located on bottom surface 124 of the cooking vessel) in the center of the cooking vessel where the sensor 135 makes temperature measurements. The concentric rings 110 preserve the accuracy of the temperature reading taken by the sensing element 130 (which includes the described IR thermometer). The concentric rings 110 enable the sensor 135 to determine a temperature that is that of the cooking vessel 120 itself without interference from the heating element 140 of the burner assembly 150. Isolating the cooking vessel 120 temperature in automating shutoff and adjustments (which are discussed herein) provides safe and effective cooking as without this isolation, a sensor could conceivably sense a temperature other than the cooking vessel 120, which could be misleading, such as the temperature of the ionized gases, flames and/or waves of superheated air involved in cooking which have a temperature far above that of the cooking vessel 120. Thus, the concentric rings 110 eliminate this measurement interference so that the IR pyrometry measurements taken by the sensing element 130 and provided to or obtained by the control system 145 are accurate. The support provided to the cooking vessel 120 by the concentric rings 110 serves to reduce interference. The (flush) fit of the cooking vessel 120 atop the concentric rings 110 produces considerable resistance to heat flow inward, and the air temperature becomes progressively cooler towards the center of the concentric rings 110, the sensing area. Rather than leaking through the tiny crevices over the rings and into the next inner chamber, the heat energy is either absorbed by the cooking vessel 120 or travels outward and away into free space.

As illustrated in FIG. 1, the control system 145 is communicatively coupled to the sensing element 130. The control system 145 obtains temperature data from the sensing element and based on these data, determines (e.g., program code executing on this microcontroller which includes a processor), whether to adjust the power provided to the heating element 140. The microcontroller can be preconfigured to determine whether a given temperature is safe, including whether the temperature is safe for a specific cooking goal. Thus, in addition to turning off or limiting the power to prevent a fire, the control system 145 can also maintain an optimal temperature for a given cooking endeavor. For example, the control system 145 can be communicatively coupled to a database of desired cook temperatures and/or times and based on data provided by a user via a user interface 190, which is communicatively coupled to the control system 145, the program code can continuously monitor and adjust the power provided to the heating element 140.

The complexity and functionality of the microprocessor of the control system 145, and hence, the functionality of the controls, can be enhance via the inclusion of more complex functionality in the code executed by the microprocessor. Once the sensing element 130 provides a temperature, the logic as to how to react to that temperature (how and whether to control the system 100 to respond), can be based on program code executed by the microprocessor or microcontroller of the control system 145. Program code executed on the control system 145 can be updated to include intelligent features and benefits, including but not limited to, convenience settings, cooking profiles, and/or timeout periods that can automatically roll back the heat level to a pre-set level after a preset time period has expired. Other convenience settings can include boil, simmer, sauté, keep warm, braise, fry, sear, sterilize, melt (butter, solid oils, cheese, chocolate, wax), poach and even thaw (wherein the program code can maintain a pre-configured temperature based on user input indicating these particular functions are being performed). The program code can be updated to include features such as: keeping pots warm automatically after the cook timer expires, health settings which regulate temperature based on a user indicating (via the user interface) the use of certain cooking tools or ingredients (e.g., Teflon, olive oil, etc.). Certain examples of the system disclosed herein may provide a user setting (via the user interface) to enable a the user to switch the functionality of the system from closed loop cooking to open loop cooking.

In some examples, the user can communicate with the control system 145 via a mobile application executing on a personal computing device of the user. Over a network connection (e.g., internet, wi-fi), the user can communicate with the control system 145 to initiate and/or stop cooking activities, and/or to obtain status of cooking activities which are in progress and are being monitored (e.g., in real-time) by the control system 145. The mobile device could enable the user to view, in real-time, activity on a remote stove-top, related to temperature and cooking time.

These are just certain examples of how the control system 145 can react based on obtaining the temperature from the sensing element 130. The control system 145 enables the transformation of cooking into a more automated process so that a user can, for example, safely walk away from the stove or multitask with complete confidence while the stove cooks the food safely. The usage of the control system 145 also eliminates human error that is inherent to the cooking process; meals can be both heathier and taste better because the control system 145 implements consistent and precise temperature control. In some examples, when the sensing system 130 no longer senses a temperature, because the cooking vessel 120 has been removed from the burner assembly 150, the control system 145 can automatically shut down the heating element.

To further increase the accuracy of the temperature determinations by the sensing element 130, certain examples can include a fan or air pump 195. The fan or air pump 195 serves to mitigate the impacts upon the temperature readings of a small volume of hot gases which could find their way through the tiny spaces between the concentric rings 110 and the cooking vessel 120, and into the central chamber which comprises the target surface. Directed into the central chamber from below the cooktop, the fan or pump 195 can provide positive pressure to overcome any residual inward flow of heat. In cases where the contact point(s) between the concentric rings 110 and the cooking vessel 120 are not flush, the inclusion of the fan or pump 195 can improve system accuracy. When the isolation and support element is concentric rings 210 (110), the fan or pump 195 can be a diaphragm pump as the diaphragm pump can overcome the resistance in the enclosed chambers (the enclosed chambers being created by the concentric 110 rings (as walls) and the cooking vessel 120, resting on the concentric rings 110, providing a roof to the chamber defined by the space between the concentric rings 110. The fan or pump 195 utilized in examples with concentric rings 110 could be selected to provide higher pressure than a fan or pump 195 selected for examples with a spiral 212 (FIG. 2) to enable, with the closed chambers, high pressure such that air can force its way over the top of the rings, thereby putting cooler air into the chambers. In contrast, in examples with a spiral 212 insulation and support element, a lower pressure fan or pump 195 could be utilized to provide this air movement.

In some examples, rather than utilizing concentric rings 110 as an isolation and support element, the isolation and support element centered in the heating element can be an open spiral structure. This configuration is also illustrated in FIG. 2. Rather than creating isolation chambers and distinct rings, the spiral creates a continuous spiral channel from its inner diameter or concentricity, to its outer, with the open area in the center for the IR pyrometer 132 of the sensing element 130 to access the target surface of the cooking vessel 120 (from which emissions are sensed by the pyrometer 132). Hence, the IR pyrometer 132 and a laser emitting diode (LED) 134 (the LED provides a laser pointer) can be positioned such that they are aimed through this open area in the center. Like concentric rings, the spiral configuration contains progressively cooler air as one moves from the heat source inward, towards the sensing area. Unlike the concentric rings 110 210 configuration, the examples that include the spirals (e.g., 212) have open ends (rather than a closed spiral having its inner and outer openings blocked) to allow air to move freely through its spiral path, from its inner concentricity to its outer, due to the positive pressure provided by the air mover. Hence, a spiral configuration creates a continuous spiral channel between its vertical barriers. Whether concentric or spiral, the thermal isolation rings create a main, central chamber 198 where temperature measurements are taken on the bottom of the cooking vessel by a non-contact infrared pyrometer (of the sensing element 130). The examples herein that include the spiral 212 can have open ends at both its inner and outer concentricities (and/or minor and major diameters) with an entrance hole at a minor diameter and an exit hole at a major diameter. The open spiral can allow air to more easily travel, radially outward, through the channel.

Some examples of the system 100 can include openings, slots or relief holes which provide a small number of restrictions. This aspect can create a slight but desirable positive pressure in the central measurement chamber 198 to overcome the inward flow of heat from the burner, which might otherwise pass over the thermal isolation rings, and into the center.

As aforementioned, a user can monitor the functionality of the system 100 via a user interface 190, which is communicatively coupled to the control system 145. Thus, via the user interface 190, a user can receive detailed status notifications. The user interface 190 can also provide a user with selectable cook times and enable a user to select automatic shutdowns under certain pre-defined circumstances. The user interface 190 can also display various notifications (e.g., “Burner #3 cooking for 27 minutes,” “Pot removed from burner . . . burner #1 now off”). Alerts can be sent via the user interface 190 can increase the awareness and engagement of the user (e.g., “Set temperature reached, cook timer started,” “Caution: 350° F.—do not use plastic utensils.”). The system 100 can be supplemented with additional sensors to create a child safe mode which sounds an alarm if the stovetop is in use and hence hot to the touch. In addition to user notifications, there are other elements which increase cooking safety over existing approaches. For example, automatic shutdown when temperatures are adjudged problematic can reduce issues such as explosions, contamination of food by faulty cookware, and financial loss due to burnt cookware. In general, use of the system 100 creates consistency, from cooking temperature, to cooking time, to results.

Although not depicted in FIG. 1, in some examples, the system 100 can include an external sensor, such as a wired probe, to calibrate the temperatures utilized by the system 100. To calibrate the temperature, a user can participate in a cooking activity with a known temperature, for example, boiling a pot of water. An additional sensor can monitor this activity and program code executing on the control system 145 can obtain a temperature from the external sensor and utilize it to calibrate the sensing element 130. Thus, the control system 145 maintains consistent cooking temperatures based on calibrating and/or obtaining data from the sensing element 130.

The workflow 300 of FIG. 3 is relevant to both the ring and the spiral configuration for the isolation and support element of the system 100. Specifically, FIG. 3 is a workflow 300 which illustrates the certain of the functionality of the system 100 of FIG. 1. FIG. 3 references elements which are depicted in FIGS. 1 and 2. In FIG. 3, a user places a cooking vessel atop the cooktop in contact (e.g., flush) with concentric rings 110 (or spiral element) and at an orientation at which the cooking vessel 120 can be heated by a heating element 140 (310). The user controls the heating element 140 to heat the cooking vessel 120 (to cook items contained in the vessel and/or to heat the vessel itself) (320). A sensing element 130 monitors a target surface on the cooking vessel 120 (the target surface is a bottom surface of the cooking vessel which is oriented at a central location in the central circle formed by an inner ring of the concentric rings 110) (330). A control system 145 communicatively coupled to a sensor of the sensing element 130 continuously obtains a temperature from the sensor of the sensing element 130 (340). The control system 145 (e.g., program code executing on a processor of the control system) determines whether a temperature obtained indicates an issue (e.g., exceeds a threshold) (350), and based on determining that the temperature indicates an issue, the control system (e.g., program code executing on a processor comprising the control system) controls a device 185 to adjust the temperature (360). The control system can continuously sense adjustment commands to the device until the temperature sensed by the sensor and obtained by the control system is adjudged by the control system to no longer indicate an issue. Thus, the system, in some examples, does not provide a single adjustment, but rather, continuously and/or progressively adjusts the temperature. As noted above, the control system can also adjust the power provided to the heat element based on the length of cooking if the user provides (or a database provides) the control system with a cook time and that is desired for a given cooking project.

FIG. 4 is another example of a workflow that can be performed by elements of the system 100 of FIG. 1. In this example, the user sets (requests) a specific cook temperature which is maintained by the system 100. Referring to FIG. 4, a user places a pot on a burner and sets a temperature via a control panel of the system (410). The user turns on the burner and the warm-up period begins at full power (for example), for rapid heating (420). An IR thermometer of the sensing element obtains real-time temperature measurements of the pot (430). The program code of the control system (the feedback input of the control system) obtains the input (440). The control system can display the input received in a user interface (e.g., on a panel of the stove in degrees) (450). The program code compares the feedback to the set temperature (e.g., setpoint) (455) and adjusts the heat level of the burner to make the feedback (pot temperature) match the set temperature (460). When the feedback precisely matches the setpoint, the warm-up period ends, and the program code (utilizing the control devices) decreases the heat level automatically to hold the temperature steady and precisely regulate the temperature (470). In this example, as liquids slowly boil away or the food cooks down, the program code can automatically adjust the burner level, decreasing it in lock step with maintaining a fixed temperature. Because the monitoring is continuous, the program code can determine if a user were to add more food or water to the pot (cooking vessel 120), and the system can automatically restart another rapid warm-up phase at full power.

The examples herein include system, method of using system, and methods of making systems which automatically maintain a consistent temperature when utilizing a cooktop or range.

An example of the system can include at least two insulating rings, each ring with a flat top surface and a flat bottom surface, positioned concentrically to each other with a first distance separating each insulating ring of the at least two insulating rings from a next insulating ring of the at least two insulating rings, where the flat bottom surface of each ring is positioned on a top surface of a range such that an upper surface of the range is in physical contact with at least a portion of the flat bottom surface of each ring, and where a first ring is an innermost ring and a second ring is an outmost ring. The system can also include a heating ring comprising a bottom surface, where the heating ring is positioned on the top surface of the range and around a perimeter of the outermost ring of the at least two insulating rings, where a second distance separates the heating ring from the outermost ring. The system can include a cooking vessel positioned on the flat top surface of the at least two insulating rings, where a portion of the cooking vessel and the innermost ring form a circular chamber. The system can include a sensor comprising an infrared pyrometer and a laser pointer, where the infrared pyrometer detects a temperature of a target surface of the cooking vessel, where the target surface is a location on a bottom surface of the cooking vessel accessible to the infrared pyrometer based on utilizing a laser pointer to emit a laser perpendicular to the upper surface of the range through the circular chamber to guide the infrared pyrometer. The system can include a control system communicatively coupled to the sensor and to at least one control device. The system can include a control device, where the control device controls power output to the heating ring, and the control device is communicatively coupled to the control system.

In some examples, the control system further comprises a memory and one or more processors in communication with the memory, where the computer system is configured to perform a method. The method can include obtaining, from the sensor, the temperature, The method can also include determining, based on one or more pre-configured conditions, whether the temperature is outside an expected result. The method can include based on determining that the temperature is outside of the expected result, controlling, the control device to adjust the power output to the heating ring.

In some examples, the control device comprises an electronic switching device.

In some examples, the control device comprises a gas valve.

In some examples, the system include a fan or pump, where the fan or pump is positioned to generate positive pressure in the circular chamber.

In some examples, the sensor further comprises a printed circuit board (PCB), where the printed circuit comprises the infrared pyrometer, where the laser pointer is comprises an LED and the laser pointer guides the infrared pyrometer.

In some examples, the PCB is mounted vertically and axially aligned with a concentric center of the system.

In some examples, the PCB is mounted horizontally.

In some examples, the system includes a data source communicatively coupled to the one or more processors.

In some examples, determining whether the temperature is outside an expected result comprises: parsing, business rules retained in the data source to identify whether the temperature is outside the expected result.

In some examples, the system includes a second sensor, where the second sensor is coupled to the cooking vessel, the second sensor communicatively coupled to the control system.

In some examples, the method performed by the control system includes obtaining a second temperature from the second sensor; and calibrating, the sensor based on the second temperature.

In some examples, a grate positioned above the heating ring to maintain a given vertical distance between the heating ring and the grate, where a portion of the cooking vessel is positioned on the grate.

In some examples, a user interface communicatively coupled to the one or more processors. The method can include displaying, in the user interface, the temperature.

In some examples, the method performed by the control system includes obtaining, via the user interface, a desired temperature and a desired cook time, where the desired temperature and the desired cook time are the one or more pre-configured conditions.

In some examples, the method performed by the control system includes determining, based on obtaining the temperature from the sensor, that the cooking vessel has been removed from the range. The method can also include the control system controlling the control device to terminate the power output to the heating ring.

In some examples, the system can include an insulating element. The insulating comprises a flat top surface and a flat bottom surface. The flat bottom surface is positioned on a top surface of a range such that an upper surface of the range is in physical contact with at least a portion of the flat bottom surface. The system can also include a heating ring comprising a bottom surface, where the heating ring is positioned on the top surface of the range forming a perimeter around the insulating element. The system can also include a cooking vessel positioned on the flat top surface of the insulating element. The system can also include a sensor comprising an infrared pyrometer and a laser pointer, where the infrared pyrometer detects a temperature of a target surface of the cooking vessel, where the target surface is a central location on a bottom surface of the cooking vessel. The system can also include a control system communicatively coupled to the sensor and to at least one control device. The system can also include a control device, where the control device controls power output to the heating ring, and the control device is communicatively coupled to the control system.

In some examples, the system with the spiral insulating element can include a control system that includes a memory and one or more processors in communication with the memory, where the computer system is configured to perform a method. The method can include obtaining, from the sensor, the temperature and determining, based on one or more pre-configured conditions, whether the temperature is outside an expected result. The method can also include based on determining that the temperature is outside of the expected result, controlling, the control device to adjust the power output to the heating ring.

In some examples, the system can include a diaphragm pump, where the diaphragm pump is positioned to generate positive pressure in crevices defined by spaces between the insulating element and the cooking vessel.

In some examples, the system can include an insulating element comprising a spiral shape, where the spiral shape has a flat top surface and a flat bottom surface, where the flat bottom surface is positioned on a top surface of a range such that an upper surface of the range is in physical contact with at least a portion of the flat bottom surface. The system can also include a heating ring comprising a bottom surface, where the heating ring is positioned on the top surface of the range forming a perimeter around the insulating element. The system can also include a cooking vessel positioned on the flat top surface of the insulating element. The system can also include a sensor comprising an infrared pyrometer and a laser pointer, where the infrared pyrometer detects a temperature of a target surface of the cooking vessel, where the target surface is a central location on a bottom surface of the cooking vessel. The system can also include a control system communicatively coupled to the sensor and to at least one control device. The system can also include a control device, where the control device controls power output to the heating ring, and the control device is communicatively coupled to the control system.

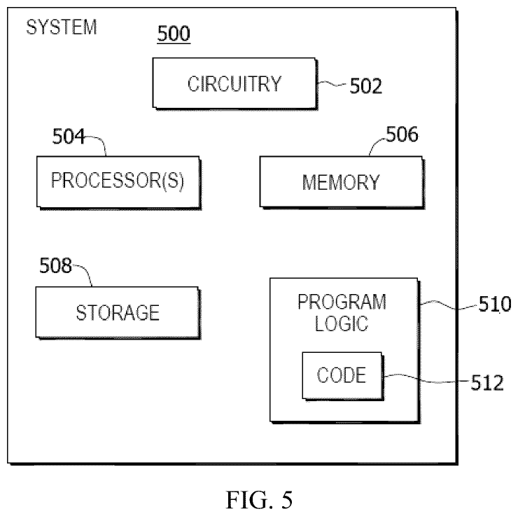

FIG. 5 illustrates a block diagram of a resource 500 in computer system, such as, which is part of the technical architecture of certain embodiments of the technique. The resource 500, in some examples, can be a microcontroller or microprocessor of the control system 145. Returning to FIG. 5, the resource 500 may include a circuitry 502 that may in certain embodiments include a microprocessor 504. The computer system 500 may also include a memory 506 (e.g., a volatile memory device), and storage 508. The storage 508 may include a non-volatile memory device (e.g., EEPROM, ROM, PROM, RAM, DRAM, SRAM, flash, firmware, programmable logic, etc.), magnetic disk drive, optical disk drive, tape drive, etc. The storage 508 may comprise an internal storage device, an attached storage device and/or a network accessible storage device. The system 500 may include a program logic 510 including code 512 that may be loaded into the memory 506 and executed by the microprocessor 504 or circuitry 502.

In certain embodiments, the program logic 510 including code 512 may be stored in the storage 508, or memory 506. In certain other embodiments, the program logic 510 may be implemented in the circuitry 502. The program logic 510 may be implemented in the memory 506 and/or the circuitry 502. The program logic 510 may include the program code discussed in this disclosure that facilitates the reconfiguration of elements of various computer networks, including those in various figures.

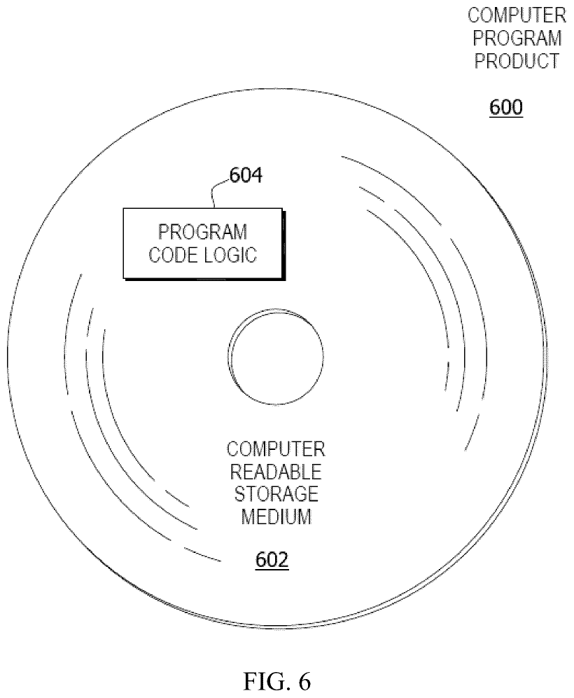

Using the processing resources of a resource 500 to execute software, computer-readable code or instructions, does not limit where this code can be stored. Referring to FIG. 6, in one example, a computer program product 600 includes, for instance, one or more non-transitory computer readable storage media 602 to store computer readable program code means or logic 604 thereon to provide and facilitate one or more aspects of the technique.

As will be appreciated by one skilled in the art, aspects of the technique may be embodied as a system, method or computer program product. Accordingly, aspects of the technique may take the form of an entirely hardware embodiment, an entirely software embodiment (including firmware, resident software, micro-code, etc.) or an embodiment combining software and hardware aspects that may all generally be referred to herein as a “circuit,” “module” or “system”. Furthermore, aspects of the technique may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable signal medium may include a propagated data signal with computer readable program code embodied therein, for example, in baseband or as part of a carrier wave. Such a propagated signal may take any of a variety of forms, including, but not limited to, electro-magnetic, optical or any suitable combination thereof. A computer readable signal medium may be any computer readable medium that is not a computer readable storage medium and that can communicate, propagate, or transport a program for use by or in connection with an instruction execution system, apparatus or device.

A computer readable storage medium may be, for example, but not limited to, an electronic, magnetic, optical, electromagnetic, infrared or semiconductor system, apparatus, or device, or any suitable combination of the foregoing. More specific examples (a non-exhaustive list) of the computer readable storage medium include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

Any combination of one or more computer readable medium(s) may be utilized. The computer readable medium may be a computer readable signal medium or a computer readable storage medium. A computer readable signal medium may include a propagated data signal with computer readable program code embodied therein, for example, in baseband or as part of a carrier wave. Such a propagated signal may take any of a variety of forms, including, but not limited to, electro-magnetic, optical or any suitable combination thereof. A computer readable signal medium may be any computer readable medium that is not a computer readable storage medium and that can communicate, propagate, or transport a program for use by or in connection with an instruction execution system, apparatus or device.

Program code embodied on a computer readable medium may be transmitted using an appropriate medium, including but not limited to wireless, wireline, optical fiber cable, RF, etc., or any suitable combination of the foregoing.

Computer program code for carrying out operations for aspects of the technique may be written in any combination of one or more programming languages, including an object oriented programming language, such as Java, Smalltalk, C++ or the like, and conventional procedural programming languages, such as the “C” programming language, PHP, ASP, assembler or similar programming languages, as well as functional programming languages and languages for technical computing (e.g., Matlab). The program code may execute entirely on the user's computer, partly on the user's computer, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). Furthermore, more than one computer can be used for implementing the program code, including, but not limited to, one or more resources in a cloud computing environment.

Aspects of the technique are described herein with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions, also referred to as software and/or program code, may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods and computer program products according to various embodiments of the technique. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

In addition to the above, one or more aspects of the technique may be provided, offered, deployed, managed, serviced, etc. by a service provider who offers management of customer environments. For instance, the service provider can create, maintain, support, etc. computer code and/or a computer infrastructure that performs one or more aspects of the technique for one or more customers. In return, the service provider may receive payment from the customer under a subscription and/or fee agreement, as examples. Additionally, or alternatively, the service provider may receive payment from the sale of advertising content to one or more third parties.

In one aspect of the technique, an application may be deployed for performing one or more aspects of the technique. As one example, the deploying of an application comprises providing computer infrastructure operable to perform one or more aspects of the technique.

As a further aspect of the technique, a computing infrastructure may be deployed comprising integrating computer readable code into a computing system, in which the code in combination with the computing system is capable of performing one or more aspects of the technique.

As yet a further aspect of the technique, a process for integrating computing infrastructure comprising integrating computer readable code into a computer system may be provided. The computer system comprises a computer readable medium, in which the computer medium comprises one or more aspects of the technique. The code in combination with the computer system is capable of performing one or more aspects of the technique.

Further, other types of computing environments can benefit from one or more aspects of the technique. As an example, an environment may include an emulator (e.g., software or other emulation mechanisms), in which a particular architecture (including, for instance, instruction execution, architected functions, such as address translation, and architected registers) or a subset thereof is emulated (e.g., on a native computer system having a processor and memory). In such an environment, one or more emulation functions of the emulator can implement one or more aspects of the technique, even though a computer executing the emulator may have a different architecture than the capabilities being emulated. As one example, in emulation mode, the specific instruction or operation being emulated is decoded, and an appropriate emulation function is built to implement the individual instruction or operation.

In an emulation environment, a host computer includes, for instance, a memory to store instructions and data; an instruction fetch unit to fetch instructions from memory and to optionally, provide local buffering for the fetched instruction; an instruction decode unit to receive the fetched instructions and to determine the type of instructions that have been fetched; and an instruction execution unit to execute the instructions. Execution may include loading data into a register from memory; storing data back to memory from a register; or performing some type of arithmetic or logical operation, as determined by the decode unit. In one example, each unit is implemented in software. For instance, the operations being performed by the units are implemented as one or more subroutines within emulator software.

Further, a data processing system suitable for storing and/or executing program code is usable that includes at least one processor coupled directly or indirectly to memory elements through a system bus. The memory elements include, for instance, local memory employed during actual execution of the program code, bulk storage, and cache memory which provide temporary storage of at least some program code in order to reduce the number of times code must be retrieved from bulk storage during execution.

Input/Output or I/O devices (including, but not limited to, keyboards, displays, pointing devices, DASD, tape, CDs, DVDs, thumb drives and other memory media, etc.) can be coupled to the system either directly or through intervening I/O controllers. Network adapters may also be coupled to the system to enable the data processing system to become coupled to other data processing systems or remote printers or storage devices through intervening private or public networks. Modems, cable modems, and Ethernet cards are just a few of the available types of network adapters. One such I/O device is the user interface 190 of FIG. 1.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components and/or groups thereof.

The corresponding structures, materials, acts, and equivalents of all means or steps plus function elements in the descriptions below, if any, are intended to include any structure, material, or act for performing the function in combination with other elements as specifically noted. The description of the technique has been presented for purposes of illustration and description but is not intended to be exhaustive or limited to the invention in the form disclosed. Many modifications and variations will be apparent to those of ordinary skill in the art without departing from the scope and spirit of the invention. The embodiment was chosen and described to best explain the principles of the invention and the practical application, and to enable others of ordinary skill in the art to understand the invention for various embodiments with various modifications as are suited to the particular uses contemplated.

1. A system comprising:
at least two insulating rings, each ring with a flat top surface and a flat bottom surface, positioned concentrically to each other with a first distance separating each insulating ring of the at least two insulating rings from a next insulating ring of the at least two insulating rings, wherein the flat bottom surface of each ring is positioned on a top surface of a range such that an upper surface of the range is in physical contact with at least a portion of the flat bottom surface of each ring, and wherein a first ring is an innermost ring and a second ring is an outmost ring;
a heating ring comprising a bottom surface, wherein the heating ring is positioned on the top surface of the range and around a perimeter of the outermost ring of the at least two insulating rings, wherein a second distance separates the heating ring from the outermost ring;
a cooking vessel positioned on the flat top surface of the at least two insulating rings, wherein a portion of the cooking vessel and the innermost ring form a circular chamber;
a sensor comprising an infrared pyrometer and a laser pointer, wherein the infrared pyrometer detects a temperature of a target surface of the cooking vessel, wherein the target surface is a location on a bottom surface of the cooking vessel accessible to the infrared pyrometer based on utilizing a laser pointer to emit a laser perpendicular to the upper surface of the range through the circular chamber to guide the infrared pyrometer;
a control system communicatively coupled to the sensor and to at least one control device; and
a control device, wherein the control device controls power output to the heating ring, and the control device is communicatively coupled to the control system.

2. The system of claim 1, the control system further comprising:
a memory; and
one or more processors in communication with the memory, wherein the computer system is configured to perform a method, the method comprising:
obtaining, by the one or more processors, from the sensor, the temperature;
determining, by the one or more processors, based on one or more pre-configured conditions, whether the temperature is outside an expected result; and
based on determining that the temperature is outside of the expected result, controlling, by the one or more processors, the control device to adjust the power output to the heating ring.

3. The system of claim 1, wherein the control device comprises an electronic switching device.

4. The system of claim 1, wherein the control device comprises a gas valve.

5. The system of claim 1, further comprising:
a fan or pump, wherein the fan or pump is positioned to generate positive pressure in the circular chamber.

6. The system of claim 1, wherein the sensor further comprises a printed circuit board (PCB), wherein the printed circuit comprises the infrared pyrometer, wherein the laser pointer is comprises an LED and the laser pointer guides the infrared pyrometer.

7. The system of claim 6, wherein the PCB is mounted vertically and axially aligned with a concentric center of the system.

8. The system of claim 6, wherein the PCB is mounted horizontally.

9. The system of claim 2, further comprising:
a data source communicatively coupled to the one or more processors.

10. The system of claim 9, wherein determining whether the temperature is outside an expected result comprises:
parsing, by the one or more processors, business rules retained in the data source to identify whether the temperature is outside the expected result.

11. The system of claim 2, further comprising:
a second sensor, wherein the second sensor is coupled to the cooking vessel, the second sensor communicatively coupled to the control system.

12. The system of claim 11, further comprising:
obtaining, by the one or more processors, a second temperature from the second sensor; and
calibrating, by the one or more processors, the sensor based on the second temperature.

13. The system of claim 1, further comprising:
a grate positioned above the heating ring to maintain a given vertical distance between the heating ring and the grate, wherein a portion of the cooking vessel is positioned on the grate.

14. The system of claim 2, further comprising:
a user interface communicatively coupled to the one or more processors, the method further comprising:
displaying, by the one or more processors, in the user interface, the temperature.

15. The system of claim 14, the method further comprising:
obtaining, by the one or more processors, via the user interface, a desired temperature and a desired cook time, wherein the desired temperature and the desired cook time are the one or more pre-configured conditions.

16. The system of claim 2, the method further comprising:
determining, by the one or more processors, based on obtaining the temperature from the sensor, that the cooking vessel has been removed from the range; and
controlling, by the one or more processors, the control device to terminate the power output to the heating ring.

17. A system comprising:
an insulating element, wherein the insulating comprises a flat top surface and a flat bottom surface, wherein the flat bottom surface is positioned on a top surface of a range such that an upper surface of the range is in physical contact with at least a portion of the flat bottom surface;
a heating ring comprising a bottom surface, wherein the heating ring is positioned on the top surface of the range forming a perimeter around the insulating element;
a cooking vessel positioned on the flat top surface of the insulating element;
a sensor comprising an infrared pyrometer and a laser pointer, wherein the infrared pyrometer detects a temperature of a target surface of the cooking vessel, wherein the target surface is a central location on a bottom surface of the cooking vessel;
a control system communicatively coupled to the sensor and to at least one control device; and
a control device, wherein the control device controls power output to the heating ring, and the control device is communicatively coupled to the control system.

18. The system of claim 17, the control system further comprising:
a memory; and
one or more processors in communication with the memory, wherein the computer system is configured to perform a method, the method comprising:
obtaining, by the one or more processors, from the sensor, the temperature;
determining, by the one or more processors, based on one or more pre-configured conditions, whether the temperature is outside an expected result; and
based on determining that the temperature is outside of the expected result, controlling, by the one or more processors, the control device to adjust the power output to the heating ring.

19. The system of claim 17, further comprising:
a diaphragm pump, wherein the diaphragm pump is positioned to generate positive pressure in crevices defined by spaces between the insulating element and the cooking vessel.

20. A system comprising:
an insulating element comprising a spiral shape, wherein the spiral shape has a flat top surface and a flat bottom surface, wherein the flat bottom surface is positioned on a top surface of a range such that an upper surface of the range is in physical contact with at least a portion of the flat bottom surface;
a heating ring comprising a bottom surface, wherein the heating ring is positioned on the top surface of the range forming a perimeter around the insulating element;
a cooking vessel positioned on the flat top surface of the insulating element;
a sensor comprising an infrared pyrometer and a laser pointer, wherein the infrared pyrometer detects a temperature of a target surface of the cooking vessel, wherein the target surface is a central location on a bottom surface of the cooking vessel;
a control system communicatively coupled to the sensor and to at least one control device; and
a control device, wherein the control device controls power output to the heating ring, and the control device is communicatively coupled to the control system.
